(19) United States
(12) Patent Application Publication
(10) Pub. No.: US 2009/0107247 A1
(43) Pub. Date: Apr. 30, 2009

(54) Magnetostrictive pressure sensor with an integrated sensing and sealing part

(76) Inventors: Thaddeus Schroeder, Rochester Hills, MI (US); Elias Taye, Macomb Township, MI (US); Christopher M. Thrush, Shelby Township, MI (US)

Correspondence Address: DELPHI TECHNOLOGIES, INC., M/C 480-410-202, PO BOX 5052, TROY, MI, 48007, US

(21) Appl. No.: 11/977,252

(22) Filed: Oct. 24, 2007

(51) Int. Cl. G01B 7/00

(52) U.S. Cl. 73/779

(57) ABSTRACT

In one embodiment a sensor assembly has a magnetostrictive (MR) element in a sensor housing. The MR element has a sensing part engaged with a wire coil and a frusto-conical sealing part juxtaposed with a fluid the pressure of which is to be sensed.

### I. FIELD OF THE INVENTION

The present invention relates generally to magnetostrictive (MS) stress sensors.

### II. BACKGROUND OF THE INVENTION

Magnetostrictive (MS) stress sensors can be used to measure stress such as might be generated within the sensor by fluid pressure. Typically, an MS stress sensor includes a MS core made from material, such as nickel/iron alloy, and a coil that surrounds the core for establishing magnetic flux within the core. The flux loop continues trough the medium on the exterior of the coil. A ferromagnetic carrier, either MS or non-MS, is used to provide an improved return path for the magnetic flux as it circles the coil through the core and the carrier. The permeability of the MS core, and thus the impedance of the coil, is a function of the stress applied to the core. The coil impedance therefore provides a signal that represents the magnitude of stress within the core and, hence, the magnitude of the physical quantity causing the stress, such as fluid pressure action on the core.

### SUMMARY OF THE INVENTION

In one embodiment a sensor assembly has a magnetostrictive (MS) element in a sensor housing. The MS element has a sensing part engaged with a wire coil and a frusto-conical sealing part juxtaposed with a fluid the pressure of which is to be sensed.

The sealing part and sensing part can be unitary with each other. In some implementations the sealing part defines an end, the fluid is in a fluid chamber, and no structure is interposed between the fluid chamber and the end of the sealing part. In other implementations the sealing part defines an end separated from the fluid by a bridge defined by the sensor housing.

Non-limiting embodiments of the MS element can include a threaded part, with the sensing part being between the threaded part and the sealing part and with the parts of the MS element being made from a unitary piece of MS material. The sensing part may define a cylindrical outer periphery, and the coil can be wound around the periphery. Or, the sensing part can define a cylindrical outer periphery and a through hole, and the coil is wound through the through hole.

The sensing part defines an outer diameter and the sealing part defines a base that can have the same diameter as the sensing part. Or, the sensing part can define an outer diameter that is different than the diameter of the base.

In another aspect, a sensor assembly includes a unitary magnetostrictive (MS) element having a sensing part engaged with a wire coil and a tapered sealing part juxtaposable with a source of stress. The wire coil carries a signal generated in the sensing part representative of stress in the sensing part caused by the source of stress.

In still another aspect, a sensor is disclosed for outputting a signal representative of stress caused by a source of stress. The sensor has magnetostrictive (MS) means including a non-tapered sensing part and a tapered sealing part, and signal means configured for carrying a signal representative of stress in the sensing part of the MS means.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 shows a system in accordance with one non-limiting embodiment of the present invention;

FIG. 2 is a partial cross-sectional view of a first embodiment of the MR sensor assembly, showing the sealing part of the MR element in contact with the fluid chamber;

FIG. 3 is a cross-sectional of an alternate embodiment in which the sealing part of the MR sensor is separated from the fluid chamber by a bridge;

FIG. 4 is a side view of a the sensor assembly showing an integrated sensor core with bolt head, threaded part, sensing part, and sealing part;

FIGS. 5 and 6 show alternate configurations of the sensing part of the assembly for holding the excitation coil; and

FIGS. 7 and 8 show alternate sensor core configurations.

### DETAILED DESCRIPTION OF THE PREFERRED EMBODIMENT

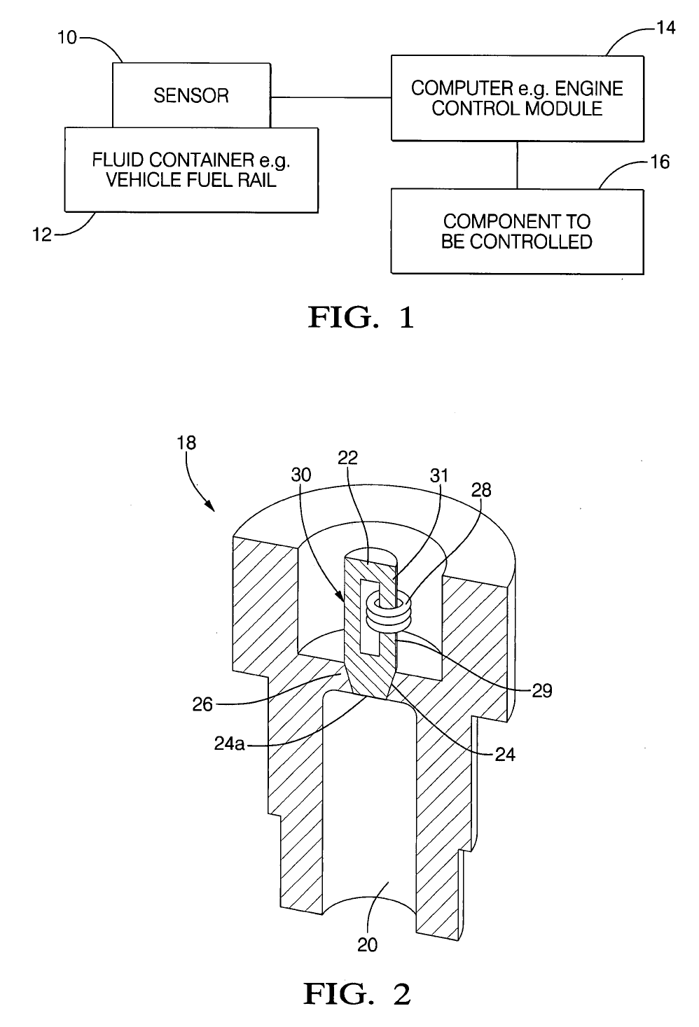

Beginning with FIG. 1, a general, non-limiting implementation of an MS stress sensor 10 is shown. The MS stress sensor 10 can be coupled to a source of pressure, such as to a fluid container 12, with the MS stress sensor 10 having the ability to sense fluid pressure in the fluid container 12 in accordance with principles below. Without limitation, the fluid container 12 may be, e.g., a vehicle fuel rail, an engine combustion chamber, etc., although present principles are not limited to any particular fluid (liquid or gas) application. The core of the sensor 10 is made of a magnetostrictive material such as, e.g., nickel/iron alloys, pure nickel, terfenol, galfenol. Preferred non-limiting materials include maraging steel (steel with about 18% nickel content) and nickel-iron alloys with 30%-70% nickel content.

The MS stress sensor 10 is also electronically connected to a computer 14 which may be, without limitation, an engine control module. The computer 14 receives the signal that is output by the sensor 10 for processing the signal to, e.g., correlate the stress as indicated by the signal to a fluid pressure. Further, the computer 14 may be electronically connected to a component 16 such as a fuel pump that may be controlled by the computer 14 based on data received from the MS stress sensor 10.

A first embodiment of an MS sensor assembly is shown in FIG. 2. The present embodiment can be used for sensing either, relatively low pressures, or for sensing relatively high pressures depending on the strength of the selected MS core material. A strong material is understood here to be a material with high yield strength.

A sensor housing 18 is shown with a fluid chamber 20 inside at least part of the housing 18. FIG. 2 also shows a core 22 that is made of a MS material. The core 22 embodies a frusto-conical sealing part 24 which substantially prevents fluid from leaking from the fluid chamber 20 to components discussed below. Specifically, the sealing part 24 defines an end 24a of the MS core 22 and no structure is interposed between the fluid chamber 20 and the end of the sealing part 24, such that the MS core 22 functions as both a sensing element and a sealing element. It may be appreciated that the frusto-conical shape of the core 22 shown in FIG. 2 provides a convenient and effective solution for sealing fluids under pressure and is also easier to manufacture than corresponding flat surfaces that seek to accomplish the same purpose.

With more specificity regarding the above-discussed sealing feature, the housing 18 can form a frusto-conical separation wall 26 as also shown in FIG. 2, which closely receives the sealing part 24a of the core 22 to facilitate preventing fluid in the fluid chamber 20 from leaking past the core 22. Related components to the core 22 include a coil 28 that is wound around a side 29 of an aperture in the cylindrical sensing part 30 of the core 22. The coil 28 may induce magnetic flux in an integrated flux return path 31 upon which a magnetic flux may exist, the magnetic flux being generated by an alternating current in the coil 28. As pressure from the fluid chamber 20 acts on the core 22 a signal indicative of flux is generated that indicates the amount of pressure currently in the fluid chamber 20. Variations of the coil 28 will be discussed in greater detail in the descriptions below. The coil 28 may thus be supplied with AC current from a current source to generate a magnetic flux in the core 22 and then a corresponding AC voltage can provide signals representative of the changing flux in the core and, hence, the pressure in the fluid chamber. The respective roles of the current and voltage can also be reversed, that is, the coil 28 may be energized by an AC voltage source to generate a magnetic flux in the core 22 and then a corresponding AC current can provide signals representative of the changing flux in the core and, hence, the pressure in the fluid chamber.

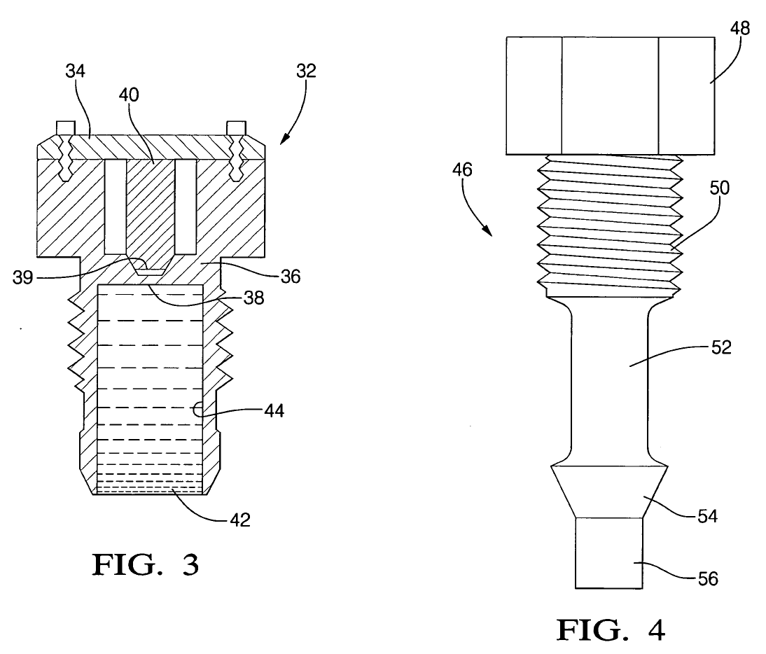

Moving to FIG. 3, an alternate embodiment of the MS stress sensor 10 is shown, the alternate embodiment being designed for MS stress sensors operating in relatively high pressure situations where having a sealing element of an MS core interposed directly between a fluid chamber and the rest of an MS core may damage or cause malfunction to an MS core composed of a weaker MS material. Thus, a structure for relieving some stress created by fluid pressure before the stress acts on the MS sensor element is shown in FIG. 3.

A sensor housing 32, which may in non-limiting embodiments include a cover 34, is shown. The cover 34 ensures a stable and secure fit of a sensor core 40 inside the sensor housing 32 maintaining a sufficient compressive force for both, fluid sealing and minimizing airgaps in the path of the magnetic flux. The sensor housing 32 with core 40 is substantially similar to the sensor housing 18 and core 22 shown in FIG. 2, with the following exceptions. Distinguishing from the first embodiment, a frusto-conical separation wall 36 similar to the separation wall 26 of FIG. 2 is shown, but in the second embodiment the separation wall 36 also includes a stress-relieving bridge 38 that is defined by the sensor housing 32 and that separates the bottom end 39 of the MS sensor element 40 from fluid 42 under pressure in the fluid chamber 44. The stress-relieving bridge 38 advantageously reduces fluid pressure by carrying some stress away from the MS sensor element 40 before any resulting pressure acts on it.

Regarding the MS sensor element 40, it is to be understood that it includes both a coil and an MS core and that it is substantially similar to the MS sensor element described FIG. 2. Further, the stress-relieving bridge 38 advantageously allows the MS sensor element to be made out of any MS material, and not just one capable of functioning under relatively high amounts of pressure. Further still, as a result of force applied by fluid pressure, the cover 34 keeps the MS sensor element 40 static and in its proper position within the sensor housing 32.

To further ensure that an MS sensor element remains fixed in its intended position within a sensor housing, FIG. 4 shows a threaded part on an MS sensor core which may be used in non-limiting embodiments. More particularly, FIG. 4 shows a unitary MS sensor core 46 that is shown outside its embodiment in a sensor housing. The MS sensor core 46 includes, from top to bottom, a hexagonal head 48, along with a threaded part 50 which secures the core 46 in a housing through threadable engagement. Below the threaded part 50 is a sensing part 52 through which a magnetic flux permeates, and a frusto-conical sealing part 54 above a fluid cavity 56 which contains fluid under pressure.

Accordingly, the sensing part 52 is between the threaded part 50 and the sealing part 54, with the threaded part 50 engageable with a threaded hole in a sensor housing (not shown in FIG. 4). Further, the MS element 46 is made from a unitary piece of MS material. Thus, the FIG. 4 embodiment of an MS sensor core may be easily assembled while also eliminating the need for a cover because of the added threaded feature. Further still, and although a variety of means can be envisioned to secure the thread 50 to the housing (not shown), the hexagonal head 48 shown in FIG. 4 also makes assembly of an MS stress sensor 10 easier because of its ability to secure the entire MS sensor core 46 using a tool such as a wrench.

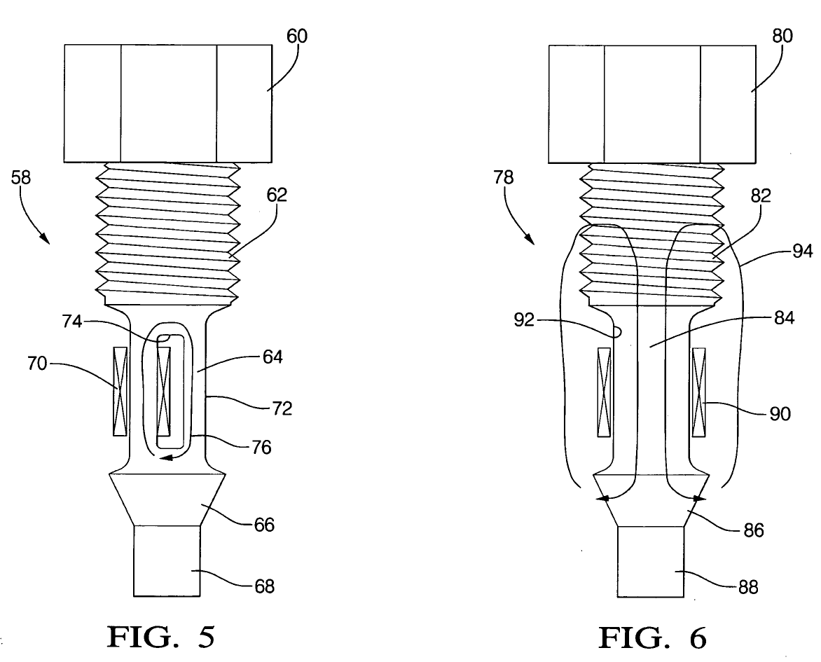

FIG. 5 shows one configuration of an MS sensor core's assembly for holding an excitation coil. The MS sensor core 58 is substantially similar in function and configuration to the MS sensor core 46 in FIG. 4, with the exceptions below. The MS sensor element 58 has a hexagonal head 60, a threaded part 62, a sensing part 64, and a sealing part 66 that is integrated into the separation wall of a sensor housing (not shown), all the preceding parts being substantially similar in function to the hexagonal head 48, threaded part 50, sensing part 52, and sealing part 54 referenced in FIG. 4, respectively. A fluid cavity 68 is also shown, which is to be understood to contain fluid under pressure.

FIG. 5 also shows a coil 70 that is substantially similar in function to the coil 28 in FIG. 2. The sensing part 64 defines a cylindrical outer periphery 72 and, unlike the core 46 in FIG. 4, a through hole 74. FIG. 5 shows the coil 70 being wound through the through hole 74 plural times. As indicated by FIG. 5, magnetic flux 76 can permeate the core 58 and in essence is confined to closely circumscribe the through-hole 74. Generally, if gaps of air exist within a magnetic flux path, the inductance of the coil 70 is weakened or varied as a result, which in turn weakens and/or varies the signal strength to be measured. Advantageously, the configuration of the coil 70 shown in FIG. 5 allows for a stronger signal strength because of an air-gapless path of magnetic flux 76, made possible by the unitary core design above.

Alternatively, FIG. 6 shows another possible configuration of an MS sensor core assembly for holding an excitation coil. The MS sensor element 78 is substantially similar to the MS sensor core 46 in FIG. 4. The MS sensor element 78 has a bolt head 80, a threaded part 82, a sensing part 84, and a sealing part 86 that is to be integrated into the separation wall of a sensor housing (not shown), all the preceding parts being substantially similar in function to the bolt head 48, threaded part 50, sensing part 52, and sealing part 54 referenced in FIG. 4, respectively. A fluid cavity 88 is also shown, which is understood to contain fluid under pressure.

FIG. 6 also shows a coil 90 and a cylindrical outer periphery 92 defined by the sensing part 84. The coil 90 is substantially similar in function to the coil 28 referenced in FIG. 2. Further, the coil 90 is wound around the cylindrical outer periphery 92 of the sensing part 84. Distinguishing FIG. 6 from FIG. 5, in FIG. 6 the magnetic field establishes a loop of flux 94 that extend through a substantial portion of the core 78 including the threaded part 82 and the sealing part 86, as well as the sensing part 84. Both the threaded part 82 and the sealing part 86 are unitary with the sensing part 84 and made of the same MS material, thus allowing a uniform magnetic flux to travel through all three parts. It should also be noted that while the magnetic flux 94 loops outside the sensor core 78 in FIG. 6, the magnetic flux 94 still essentially does not encounter any air gaps because the outer portions of the magnetic flux 94 shown outside the sensor core 78 actually loop through a sensor housing that is not shown, the sensor housing understood to be in physical contact with the sensor core 78. Thus, an air-gapless magnetic flux is also substantially achieved in FIG. 6. Moreover, the coil configuration shown in FIG. 6 also simplifies the coil winding method compared to a method that would have to be used when winding a coil through a through hole.

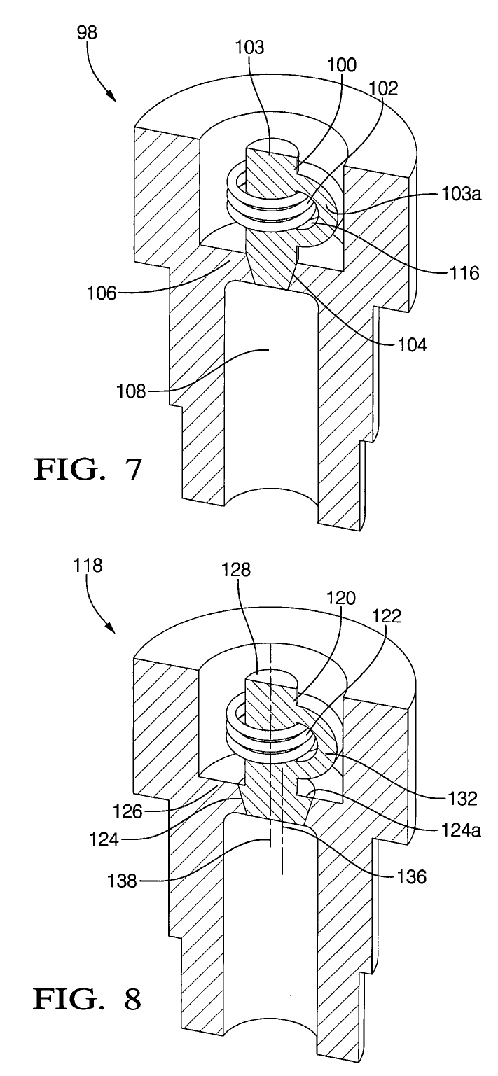

Moving from coil configurations to sensor core configurations, FIGS. 7 and 8 show alternate sensor core configurations. FIG. 7 shows a sensor core configuration that has sealing and sensing parts with the same diameter at their interface with each other.

A sensor housing 98 which houses the sensor core 100 is shown. The sensor core 100 is substantially similar in function and configuration to the sensor core 22 in FIG. 2 except as noted below. A coil 102 is wound around a solid cylindrical sensing part 103 through an opening 116 that is established between the sensing part 103 and an integrated handle 103a that joins the sensing part 103 at upper and lower interfaces as shown. This configuration allows for increased permeability of the sensor core 100, which in turn increases signal strength generated by a magnetic flux in the core 100. Also, the sensor core 100 has a sealing part 104 that closely engages a separation wall 106 of the housing 98 to prevent fluid in the fluid cavity 108 from reaching other parts of the core 100.

In the configuration shown in FIG. 7, the sensing part 103 defines an outer diameter that is the same as that of the sealing part 104 at the interface between the two parts, with the diameter of the sealing art 104 tapering inwardly from the interface as shown.

It is to be generally understood that the relevant feature of this particular embodiment is that a sensing part and a sealing part have the same base dimensions, i.e., the same cross-sectional area at their interface. While this embodiment provides a sensor core having sensing and sealing parts with the same cross-section at the interface, it is to be generally understood without limitation that the cross-section of the sealing part of a sensor core may be larger or smaller than the cross-section of the sensing part of a sensor core at the interface between the parts.

Such a configuration is shown in FIG. 8, which depicts a sensor housing 118 that holds a sensor core 120. The sensor core 120 is substantially similar to the sensor core 100 in FIG. 7 with the exceptions noted below. A coil 122 can be substantially similar to the coil 28 from FIG. 2.

Also substantially similar to previous embodiments referenced above, the sensor core 120 has a frusto-conical sealing part 124 that engages a separation wall 126 of the housing 118. The sensor core 120 also has a sensing part 128 which is substantially similar to the sensing part 103 in FIG. 7.

Now distinguishing from previous embodiments, the sealing part 124 defines a base 124a having a diameter different from the outer diameter defined by the sensing part 128. Furthermore, the axis 136 of the sealing part 124 is offset from the axis 138 of the sensing part 128. While sensing and sealing parts of an MS sensor core may without limitation have axes coaxial with each other, in the embodiment of FIG. 8 it is advantageous to have the axis 136 of the sealing part 124 be offset from the axis 138 of the sensing part 128, for the following reason. It is to be generally understood that the active portion of the sensing part 128 is the area near the coil where a magnetic flux is strongest, in particular as a result of eddy current effects. Therefore, it is advantageous to offset the axis 138 of the sensing part 128 so that the axis 136 of the sealing part 124 may be in closer proximity to the active portion of the sensing part 128 because most of the stress caused by fluid pressure in the fluid cavity 130 will be transferred along the axis 136 of the sealing part 124. Thus, the active portion of the core 120 advantageously receives more stress from fluid pressure as a result of the axes in FIG. 8 being offset, increasing stress-related permeability changes in the core 120, which in turn increases signal strength generated by a magnetic flux in the core 120.

It is to be understood that a cylindrical sensing part is not the only shape that may be used in the non-limiting embodiment of a sensor core shown in FIGS. 7 and 8. For instance, a parallelepiped shaped sensing part may be used, having a rectangular cross-section interfacing with the circular base of a frusto-conical sealing part. Furthermore, the tops of the sensing parts in FIGS. 7 and 8 are omitted for clarity, it being understood that a cover such as that shown in FIG. 3 or a threaded portion such as those shown in FIGS. 4-6 may be used in the embodiments of FIGS. 7 and 8.

While the particular MAGNETOSTRICTIVE PRESSURE SENSOR WITH AN INTEGRATED SENSING AND SEALING PART is herein shown and described in detail, it is to be understood that the subject matter which is encompassed by the present invention is limited only by the claims.

What is claimed is:

1. A sensor assembly, comprising:
a magnetostrictive (MS) element in a sensor housing, the MS element having a sensing part engaged with a wire coil and a frusto-conical sealing part juxtaposed with a fluid the pressure of which is to be sensed.

2. The assembly of claim 1, wherein the sealing part and sensing part are unitary with each other.

3. The assembly of claim 1, wherein the sealing part defines an end, the fluid is in a fluid chamber, and no structure is interposed between the fluid chamber and the end of the sealing part.

4. The assembly of claim 1, comprising a sensor housing holding the MS element, wherein the sealing part defines an end separated from the fluid by a bridge defined by the sensor housing.

5. The assembly of claim 1, wherein the MS element further comprises: a threaded part, the sensing part being between the threaded part and the sealing part

6. The assembly of claim 5, wherein the MS element is made from a unitary piece of MS material.

7. The assembly of claim 5, wherein the sensing part defines an outer periphery, the coil being wound around the periphery.

8. The assembly of claim 5, wherein the sensing part defines an outer periphery and a through hole, the coil being wound through the through hole.

9. The assembly of claim 1, wherein the sensing part defines an outer diameter and the sealing part defines a base having the same diameter as the sensing part.

10. The assembly of claim 1, wherein the sealing part defines a base having a diameter and the sensing part defines an outer diameter different than the diameter of the base.

11. A sensor assembly, comprising:
a unitary magnetostrictive (MS) element having a sensing part engaged with a wire coil and a tapered sealing part juxtaposable with a source of stress, the wire coil carrying a signal generated in the sensing part representative of stress in the sensing part caused by the source of stress.

12. The assembly of claim 11, wherein the sealing part defines an end, the MS element being positioned with the end closing an opening in a fluid chamber holding fluid.

13. The assembly of claim 11, comprising a sensor housing holding the MS element, wherein the sealing part defines an end separated from a fluid chamber by a bridge defined by the sensor housing.

14. The assembly of claim 11, wherein the MS element further comprises: a threaded part, the sensing part being between the threaded part and the sealing part

15. The assembly of claim 14, wherein the MS element is made from a unitary piece of MS material.

16. The assembly of claim 14, wherein the sensing part defines an outer periphery, the coil being wound around the periphery.

17. The assembly of claim 14, wherein the sensing part defines an outer periphery and a through hole, the coil being wound through the through hole.

18. The assembly of claim 11, wherein the sensing part defines an outer diameter and the sealing part defines a base having the same diameter as the sensing part.

19. The assembly of claim 11, wherein the sealing part defines a base having a diameter and the sensing part defines an outer diameter different than the diameter of the base.

20. A sensor for outputting a signal representative of stress caused by a source of stress, comprising:
magnetostrictive (MS) means including a non-tapered sensing part and a tapered sealing part; and
signal means configured for carrying a signal representative of stress of the sensing part of the MS means.
